(19) United States
(12) Patent Application Publication
(10) Pub. No.: US 2007/0071968 A1
(43) Pub. Date: Mar. 29, 2007

(54) Tamper evident tape

(76) Inventors: Iris Hermony, Kibbutz Sde Boker (IL); Dina Berman, Beer Sheva (IL)

Correspondence Address: BROWDY AND NEIMARK, P.L.L.C.;624 NINTH STREET, NW, SUITE 300, WASHINGTON, DC, 20001-5303, US

(21) Appl. No.: 10/577,240

(22) PCT Filed:
(86) PCT No.: PCT/IL04/00975

(30) Foreign Application Priority Data
Oct. 27, 2003 (IL) 158625

(51) Int. Cl. B32B 7/12; B32B 15/04

(52) U.S. Cl. 428/343; 428/352; 428/354

(57) ABSTRACT

The present invention provides a tamper-evident multi-layered tape for use for closing boxes and similar items and packages. The tape of the present invention provides an indication which shows that the tape has been detached from the surface of the box which it is closing. The tamper-evident tape is a multi-layered tape comprising of a first and second film wherein the first surface of the first film is coated with an adhesive layer. Said first surface is the surface facing the box, package or item when applying the tape. Between the first and second film there is a failure layer comprising of layers of adhesive, primer and ink. The patterns of application of the primer, adhesive and ink creates the tamper indicating pattern. The second surface of the second film which is the outer surface of the tamper-evident tape is coated with a release layer.

### FIELD OF THE INVENTION

The present invention relates to tamper indicating tapes and labels which can be used for packaging and provides an indication of tampering when an attempt to remove the tape or label from the package has been made.

### BACKGROUND OF THE INVENTION

A major concern these days is the susceptibility of packages, containers, boxes, luggage and the like to theft, diversion, tampering or pilferage. Much effort and large sums of money are spent in an attempt to provide means for preventing these problems.

One particular solution with considerable success has been to provide a sealing tape designed to be secured to an object such as a package, which tape has one appearance when thus applied, but produces a different and distinctive appearance if the tape has been removed, even when an attempt is made to re-apply the tape. These types of tapes are known as tamper-evident tapes. For example, if such a tape is used for the sealing of a package to prevent access to the contents of the package, removal of the tape will create that different appearance, such as the display of a warning word, symbol or pattern, or a change in color.

Various types of tamper evident tapes and labels have been developed. However, the main disadvantage of these tapes and labels is in the disability to reapply the sealing tape to the package after they have been peeled off. Although these tapes provide a tamper indication when they are peeled off the package, the package then remains unsealed and in some cases completely open so that the contents may fall out or be easily removed by unauthorized people. Thus, while tamper indication is indeed provided, the security and safety of the packages contents is severely compromised. Another disadvantage is the adhesive layer being a part of the failure layer so it's sealing properties is compromise with tamper evident properties. U.S. Pat. No. 4,876,123 to Minnesota Mining and Manufacturing Company Ltd. describes a tamper indicting tape which attempts to provide a solution to the foregoing problem by providing a tape with a copolymer film layer as a backing film which is heterogeneous and delaminates internally when the tape is peeled off, hence indicating opening of the package.

An additional disadvantage which is encountered in the use of tamper evident tapes pertains to the adhesive strength between the tape and the surface of the package. In many types of tape, when the package is made of carton or other similar materials, peeling the tape from the package results in the peeling of a layer of the carton, leaving the tamper evident tape in tact. Although, the package cannot be properly closed again and the opening of the package is evident, the tape does not properly function. Attempting to overcome this problem by producing a weaker adhesive results in some cases in a weak tape which fails to seal the box.

Accordingly, there is a long felt need for a tamper-evident tape which provides tamper indication and sealing of the package after an attempt to remove the tape has been made.

It is therefore an objective of the present invention to provide a tamper-evident tape which provides tamper indication and provides sealing of the package even after an attempt to peel off the tape has been made.

It is yet a further objective of the present invention to provide a tape which overcomes the disadvantages of the tapes described in the prior art.

Other objectives of the invention shall become apparent as the description proceeds.

### SUMMARY OF THE INVENTION

The present invention provides a tamper-evident multi-layered tape for use for closing boxes and similar items and packages. The tape of the present invention provides an indication which shows that the tape has been detached from the surface of the box which it is closing. The tamper-evident tape is a multi-layered tape comprising of a first and second film wherein the first surface of the first film is coated with an adhesive layer. Said first surface is the surface facing the box, package or item when applying the tape. Between the first and second film there is a failure layer comprising of layers of adhesive, primer and ink. The pattern of application of the primer, adhesive and ink creates the tamper indicating pattern. The second surface of the second film which is the outer surface of the tamper-evident tape is coated with a release layer.

Optionally, additional release layer is applied between the first and second film at a pattern of longitudinal stripes at a fixed distance indicating the margins of the tape, hereinafter referred to as lift stripes.

### BRIEF DESCRIPTIONS OF THE DRAWING

FIG. 1 is a cross sectional view of a tamper-evident tape constructed according to a particular embodiment of the present invention.

FIG. 2 is a plan view of the tamper-evident tape when the tape has been peeled off from the packaging.

### DETAILED DESCRIPTION OF PREFERRED EMBODIMENTS

The following description is illustrative of embodiments of the invention. The following description is not to be construed as limiting, it being understood that the skilled person may carry out many obvious variations to the invention.

Throughout the description the term tamper-evident is synonymous with tamper indicating and refers to a visible indication which appears on the tape when an attempt to remove said tape from an item is made and the tape is peeled off. The terms box, package, packaging and item refer to any article to which the tape of the present invention is applied which may also include luggage, bottles and containers of various types. While the term tape is used throughout the description, the term tape also encompasses labels.

The present invention provides a multi-layered tamper-evident tape which provides an indication that the tape has been lifted from the packaging to which it is applied. The tape is applied to a box or other item in order to secure closure of the packaging. The tamper evident indication is not visible on the tape before an attempt to open the package is made and the tape is peeled off. Attempting to remove the tape from the packaging by peeling the tape results in the exposure of an indication which clearly shows that the tape was lifted from the package. The indication is generally in the form of a symbol, sign, wording or combination thereof.

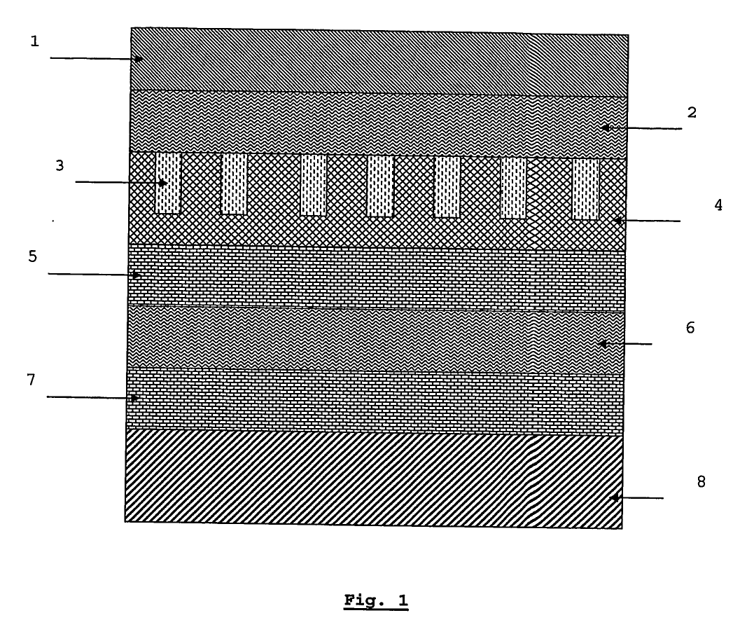

In accordance with a particular embodiment of the invention, with reference to FIG. 1, there is provided a multi layered tamper-evident tape comprising of;

a first film (6) wherein the first surface of said film is the inner surface of said tape which is applied to the packaging. Said first surface is coated with an adhesive layer (7) so that the tape binds to the packaging (8), the adhesive is suitable to the substrate to which it should adhere to. According to particular embodiments of the invention said adhesive is applied at an amount of about 15-60 gr/m²,

a second surface of said first film which is coated with a second adhesive layer (5) further coated with a layer of colored ink (4),

a second film (2) wherein the first surface of said second film, which is facing the ink layer, is treated with a layer of primer in certain areas (3) such that the ink adheres to said first surface of said second film in the areas where the primer is applied and in the areas where there is no primer, the ink adheres to the second adhesive layer of said first film stronger than it adheres to the second film. An appropriate construction and control of the adhering forces of the tape and within the tape provides consistent and dependable performance of the tape. The adhering force of the first film to the packaging is greater than the adhering force between the first and second film. This ensures that when an attempt to peel the tape off of the package is made, the second film will peel off by separating from the first film and the first film will remain adhered to the package. Thus, maintaining closure of the package. Furthermore, the adhering force of the primer layer of the one film to the ink is greater than the adhering force of the ink to the other film. In this manner, when the tape is peeled from the packaging, the first film remains adhered to the packaging and the ink layer remains adhered to the adhesive on the second surface of one film in the areas where no primer was applied to the other film. In the areas where primer has been applied to the first surface of the second film, the ink adheres to the second film and the first film remains with no ink in said areas. The pattern in which the primer layer is applied to one film is the pattern which is exposed when the films are separated as a result of attempting to peel the tape. The layers of adhesive, ink and primer which are sandwiched between the first and second film create together a layer referred to as the failure layer

According to a particular embodiment of the invention the pigmented ink applied in the failure layer is applied at 0.5-7 gr/m².

According to a further embodiment of the invention the failure layer may be applied such that the adhesive layer is applied to the first surface of the second film layer and the primer is applied to the second surface of the first film, and then coated with ink. The layering of the failure layer may be adjusted to suit the particular needs of the tape and the manufacturing process thereof.

The second surface of the second film which is the outer surface of the tamper-evident tape is coated with a release layer so that when the tape is in the form of a roll, the first adhesive layer of the inner surface of the tape does not adhere to the outer surface of the tape or adheres very weakly. It should adhere weaker than the ink layer is adhering to the first surface of the second film, thus enabling it to unwind easily, without pre-imaging of the tamper indication. The function of the release layer may also be achieved by adding a strip of release liner to the outer surface of the tape or the adhesive inner surface of the tape wherein said strip adheres weakly or does not adhere to adhesives, hence preventing the outer surface of the tape from adhering to the adhesive layer of the inner surface of the tape. The strip which can be made from paper, polymeric material or any suitable material may be peeled away easily when applying the tape.

According to a further embodiment of the invention, a release layer is applied between the first and second film at a pattern of longitudinal stripes at a fixed distance from the margins of the tape. Thus along said release layer zones, the second film does not adhere to the first film or adheres very weakly. The width of the lift stripes are about 2 to 15 mm, preferably 2 to 5 mm. The lift stripes facilitate the separation of the first and second film such that when an attempt is made to peel the tape off the packaging, the release zones along the margins of the tape between the first and second film are easily lifted thus guaranteeing proper functioning of the tamper evident tape.

According to a further embodiment of the present invention, the first film has a tensile strength in the machine direction of 5-20 Newton/inch. In yet a further embodiment said first film is perforated in a certain pattern at fixed distances. The purpose of said the film tensile strength or the perforation is to cause the first film to tear when attempting to peel off the first film of the package. This is particularly useful in situations where the tape has been peeled and the tamper-evident pattern has been exposed and a further attempt is made to open the package by peeling off the first film which remained adhered to the package. This provides improved sealing of the package.

The separation of the films wherein part of the ink layer adheres with the help of a primer to one film and part of the ink adheres to the adhesive layer on the other film creates the indication of tampering. The pattern of the indication, whether it is a symbol, wording, sign or combination thereof, is created by the pattern in which the primer layer coating is applied to the film. Non-limiting examples of tamper indication patterns in the tape may be wording such as “opened”, “void”, “Alert”, “unsealed”, “Attention”, “Warning” or various symbols.

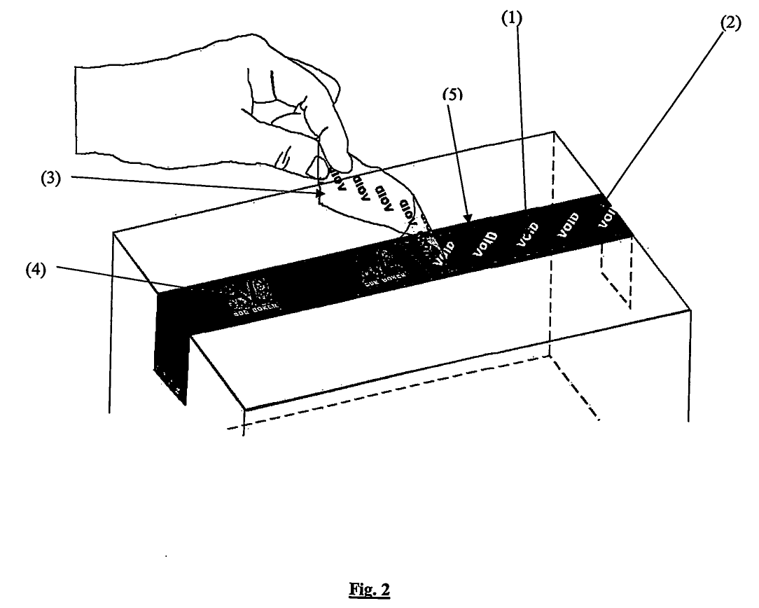

FIG. 2 demonstrates the tamper-evident tape when the tape has been peeled off from the packaging. The tamper-evident pattern “VOID” (1) is exposed when the second film (3) is peeled off. The First film (2) remains adhered to the package, thus maintaining closure of the package. The lift stripes (5) facilitate the separation of the films. Further shown is an optional printed pattern which is visible prior to peeling of the tape (4).

The tape of the present invention is particularly useful for closing packages by applying the tape so that it seals the flaps of the package. An attempt to peel the tape of the package will result in separation of the first film from the second film, hence exposing the tamper indication pattern while at the same time maintaining the package sealed by the first film which remains adhered to the package.

The films used in the construction of the tamper-evident tape of the present invention can be formed of matte or clear plastic such as polyester(PET), polypropylene, polyethylene, polyvinyl chloride (PVC), unplasticized PVC, polyamides or other suitable plastics, nonwovens and papers. According to a preferred embodiment the first film is a filter paper film and the second film is made of oriented polypropylene or polyester(PET).

The adhesive layers, pressure sensitive adhesive layers of the present invention may be formed of any suitable adhesive which has the desired adhesive properties required for a particular adhesive layer. It is well known to the skilled artisan in the field of adhesives that adhesives are often specially formulated to satisfy particular properties, so the specific nature of the adhesive layers may vary widely, and for each specific adhesive layer there are required specific modifications of the composition and properties of the adhesive employed. Non-limiting examples of the adhesives which can be used are heat activated or pressure sensitive adhesives (PSA) of the following kinds; water based, solvent based, UV curing or hot melt based. The adhesives may comprise of acrylic polymers or thermoplastic rubber and hydrocarbon resins or rosins. Preferably, the PSA comprises of thermoplastic rubber and hydrocarbon Resins or Rosins. Preferably, in hot melt or solvent base PSA. The adhesive comprises of synthetic rubber and in particular styrene-butadiene rubber, styrene-isoprene-styrene block copolymer and styrene butadiene-styrene block copolymer together with hydrocarbon resins. In acrylic PSA the adhesive may be based on an aqueous acrylate dispersion, e.g., a pressure sensitive adhesive comprising styrene isoprene styrene block copolymer tackified with hydrocarbon resin which is found to be suitable for this tamper evident tape.

The release layer (FIG. 1, (1)) which may be formed of any suitable material as known in the art, is preferably formed of a suitable silicone or carbamate material, most preferably, a silicone material.

The ink layer and the primer layer may be composed of any suitable material known in the art, e.g., water based, solvent-based flexographic printing inks, UV-curing flexographic printing inks, resin dispersions, acrylate dispersion and polymer dispersions. Preferably, resin dispersions in solvent or water, in particular, solvent base water base, heat or UV curing flexographic printing inks.

The tape of the present invention may optionally contain a printed pattern which is not part of the tamper indicating print layer. Accordingly, functional messages may be printed on the tape e.g., “fragile”, “This side up”; “Security Tape” company logos and symbols may also be applied, all of which may be visible even if no tampering occurs.

The tape of the present invention may be applied in packaging of food products, medical and pharmaceutical products, securing of various types of packaging and other known applications of adhesive tapes. Further applications may include security and law enforcement purposes such as sealing luggage and envelopes and crime scenes. While a wide array of applications may utilize the tape of the present invention, its primary advantage is embedded in the tapes ability to maintain the seal of a package even after an attempt to peel the tape has been made and the tamper indication is exposed.

### EXAMPLES

### Example 1

### Preparation of Tamper Evident Tape

The Second Film Used is:

Siliconized polyester (PET) 36 micron grade PN8666 (API, England)

The release lacquer is a solvent containing silicone.

Failuer Layers:

Contains 3 Layers (1a, b; 2; 3)

Two layers have been printed on the first surface of the second film, opposite side of the silicone release.

1a. First printed layer of transparent primer solution. The primer is adhering well to the film surface. The primer layer is not printed over the full area but in a shape of “VOID” letters. The primer is a solvent solution of a mixture of ethylenevinylacetate and chlorinated isotactic polypropylene polymers (Primer EPX-2, Ichemco srl, Italy).

1b. applying of stripes 3 mm wide marking the edges of each individual tape in order to ensure tamper evident effect in each attempts to disclose the tape. Those zones are printed with flexographic Nitrocellulose based ink (‘Polial ink series’, TZAH-Israeli printing inks Ltd.) containing 5% polyethylene wax paste.,

and thus creating very weak adhering zone between the ink and the film surface. The primer and the strips are printed on the same layer level.

2. Second layer of colored ink printed all over the first surface of the second film. This is a layer of flexographic Nitrocelulose based ink (‘Polial ink series’, TZAH-Israeli printing inks ltd.). This layer adheres well to the first primer layer but poorly to the first surface of the second film.

3. The Third layer is an adhesive layer coated all over the printed second film first surface. The adhesive is a hot melt Pressure Sensitive Adhesive based on synthetic rubber and hydrocarbon resins as follows.

| Material | Phr* |
|---|---|
| styrene-isoprene-styrene (Kraton 1107, Kraton Polymers) | 100 |
| Hydrocarbon resin (Escorez 2203, Exxon Mobil Chemicals) | 110 |
| Oil (Flexon 876, Esso S.A.F) | 10 |
| Antioxidant (Irganox, Ciba-Geigy Ltd.) | 1 |

*phr is part per hundred wherein the styrene-isoprene-styrene is calculated as 100.

4. The first film is a filter paper laminated on to the printed and coated film. Tissue paper weight 13 gram/m², Dry Tensile Strength 70 gram/cm(MB Papeles Especiales S.A).
5. On the first surface of the first film a second layer of adhesive is than coated (on the free face of the paper of the aforementioned laminate)—the adhesive composition is the same composition as the first adhesive layer. Adhesive amount 16-24 gram/m²

### Example 2

### Production of Tamper Evident Tape

The film was printed with printing machine with printing width of 150 mm-SIAT L36. The adhesive coating and paper laminating were operated with 150 mm coating machine ACUMETER LH-3.

While embodiments of the invention have been described by way of illustration, it will be apparent that the invention may be carried out with many modifications, variations and adaptations, without departing from its spirit or exceeding the scope of the claims.

It should be understood that some modification, alteration and substitution is anticipated and expected from those skilled in the art without departing from the teachings of the invention. Accordingly, it is appropriate that the following claims be construed broadly and in a manner consistent with the scope and spirit of the invention.

1. A multi-layered tamper-evident tape comprising of a first and second film wherein the first surface of the first film is coated with an adhesive layer; a failure layer between the first and second film comprising of layers of adhesive, ink and primer; and the second surface of the second film is coated with a release layer.

2. A tape according to claim 1 wherein the first surface of the second film is coated with a primer layer in certain areas and then coated with a layer of colored ink all over the area, and the second surface of the first film is coated with a layer of adhesive.

3. A tape according to claim 1 wherein the first surface of the second film is coated with an adhesive and the second surface of the first film is coated with primer layer in certain areas and then coated with a layer of colored ink all over the entire area of said second surface.

4. A tape according to claim 1 wherein the adhering force between the first and second films is weaker than the adhering force between the inner surface of the tape and the packaging substrate.

5. A tape according to any one of claims 1 to 4 wherein the second surface of the second film is coated with a release layer.

6. A tape according to any one of claims 1 to 5 wherein the release layer comprise silicone.

7. A tape according to any of claims 1 to 5 wherein the margins of the first surface of the second film and/or the second surface of the first film are coated with a release layer to create lift stripes.

8. A tape according to any of claims 1 to 7 wherein the lift stripes, the ink layer and primer layer comprise of materials selected from among a group comprising of water based, solvent-based flexographic printing inks, UV-curing flexographic printing inks, resin dispersions, acrylate dispersion and polymer dispersions.

9. A tape according to claim 1 wherein the adhesive on the first surface of the first film and the adhesive at the failure layer is selected from among a group comprising of heat activated or pressure sensitive adhesives (PSA).

10. A tape according to claim 9 wherein said adhesives are selected from among a group of adhesives comprising of water based, solvent based, UV curing or hot melt based, comprising of acrylic polymers and/or thermoplastic rubber and/or hydrocarbon resins or rosins.

11. A tape according to claims 1 wherein the first and second film are constructed of materials selected from among a group comprising of polyester(PET), styrene, polypropylene, polyethylene, polyvinyl chloride (PVC), unplasticized PVC, polyamides or other suitable polyolefins films, nonwovens and papers.

12. A tape according to claim 1 wherein the first film has a machine direction tensile strength of 5-70 Newton/inch.

13. A tape according to claim 1 wherein the first film is perforated.

14. A tape according to any of claims 1 to 8 wherein the second film separates from the first film and displays tamper evidence figures when an attempt is made to peel said tape from the surface to which it is adhered.

15. A method for closing and/or sealing boxes, packages, bottles, containers, articles and luggage comprising of applying the tape claimed in any of claims 1 to 12 to said packaging.

16. A process for the manufacture of a tamper evident tape comprising (a) incorporating a failure layer between two films; (b) coating the first surface of the first film with an adhesive; and (c) coating the second surface of the second film with a release layer.

17. A process according to claim 16 wherein the incorporation of the failure layer between the films is carried out by a process comprising of (a) applying primer to certain areas of the first surface of the second film creating a particular pattern; (b) then applying colored ink over the first surface of the second film; (c) then coating the first surface of the second film with a layer of adhesive; and (d) applying the first film to the adhesive layer of the first surface of the second film.

18. A process according to claim 17 wherein the primer is applied in a pattern matching the desired tamper-evident message.

19. A process according to claim 17 wherein the primer is applied over the entire surface with the exception of certain areas, said areas being in a pattern of the desired tamper evident message.

20. A process according to claim 16 wherein the incorporation of the failure layer between the films is carried out by a process comprising of (a) applying primer to certain areas of the second surface of the first film creating a particular pattern; (b) then applying colored ink over the second surface of the first film; (c) then coating the second surface of the first film with a layer of adhesive; and (d) applying the second film to the adhesive layer of the second surface of the first film.

21. A process according to claim 20 wherein the primer is applied in a pattern matching the desired tamper-evident message.

22. A process according to claim 20 wherein the primer is applied over the entire surface with the exception of certain areas, said areas being in a pattern of the desired tamper evident message.

23. A process according to any of claims 16 to 22 comprising of applying a release layer along the margins of the first surface of the second film and/or the second surface of the first film.
